(19) United States
(12) Patent Application Publication
(10) Pub. No.: US 2020/0180495 A1
(43) Pub. Date: Jun. 11, 2020

(54) Adjustable Trailer Bunk Brace

(71) Applicant: Mark Wheeler, Tallahassee, FL (US)

(72) Inventor: Mark Wheeler, Tallahassee, FL (US)

(21) Appl. No.: 16/214,858

(22) Filed: Dec. 10, 2018

(51) Int. Cl. B60P 3/10

(52) U.S. Cl. CPC B60P 3/1066; B60P 3/1033

(57) ABSTRACT

A lateral brace for stabilizing a bunk on a boat trailer. The brace includes an anchor bracket attached to 3 rigid portion of the trailer and a bunk bracket attached to a bunk or to a bracket connecting the bunk to the trailer. An adjustable link connects the anchor bracket to the bunk bracket. The length of the adjustable link can be varied in order to place a desired lateral force on the bunk. This lateral force counteracts the splaying force applied by a boat hull resting on the bunk.

### BACKGROUND OF THE INVENTION

### 1. Field of the Invention

The invention relates to the field of boat nailers. More specifically, the invention comprises an adjustable bunk brace configured to counteract the lateral forces exerted by a boat hull on a trailer bunk brace.

### 2. Description of Related Art

There are many different types of boat trailers but most trailers intended for small vessels include the same basic features. FIG. 1 depicts a common type of prior art trailer. The primary structure is formed by left beam 12 and right beam 14. These two beams are aluminum extrusions that are cold formed to create the desired configuration. The two beams taper inward and are linked together at junction 20. Tongue 22 extends forward from junction 20. Hitch 24 includes a trailer ball receiver and latching mechanism.

Winch post 16 is provided just aft of junction 20. Winch 18 is mounted on the winch post. Rear cross beam 26 links the aft end of beams 12, 14 to provide a unified structure. Additional cross beams—such as central cross beam 28—typically link left beam 12 and right beam 14 as well. Axle 30 is also attached to the left and right beams. In this context the term “axle” refers to the assembly of a lateral structural beam and the left and right wheel bearing stub shafts mounted on that beam. In the example shown, the beam forming part of this axle assembly is not straight. Instead, it includes a downward deflection in its center to provide additional clearance for the keel of a boat resting on the trailer.

As those skilled in the art will know, left bunk 32 and right bunk 34 support the majority of the weight of a vessel placed upon the trailer. These bunks are typically pieces of hardwood covered in a soft and waterproof fabric (often outdoor carpeting). In recent years some manufacturers have used dense polypropylene rather than wood to create the bunks. Still other manufacturers have used aluminum tubing or more complex extruded aluminum shapes. Whatever material is used, the function of a bunk is the same. The upward facing surface of the bunks may not be horizontal (as depicted) and may instead be angled to match the angle existing on the bottom of a “vee” boat hull.

Boat trailers are made in a wide variety of forms, but they tend to have some common characteristics. Left and right beams 12, 14 may be referred to as longitudinal beams, since they run generally parallel to the trailer's long axis. Cross beams (such as rear cross beam 26 and central cross beam 28) tend to span the gap between the longitudinal beams. The term “trailer chassis” includes the longitudinal beams, the cross beams and other rigid portions of the trailer.

As the reader will note in FIG. 1, the bunks are connected to rear cross beam 26 and central cross beam 28 using substantial brackets (often referred to as “L” brackets since that is a common shape for this type of bracket, although other shapes are known). The combination of a bunk and the prior art brackets used to attach the bunk to a trailer shall be referred to as a “bunk assembly” in this application. In order to recover a boat, the trailer is typically backed down a launching ramp so that the aft portion of the trailer is submerged and the boat is then driven and/or winched onto the two bunks 32, 34 until the prow contacts forward roller 19. As the boat and trailer are pulled out of the water a large portion of the boat's weight is placed on bunks 32, 34. The popularity of this beam and bunk arrangement is primarily based on the adjustability of the position of bunks 32, 34. They can be easily moved laterally and vertically to accommodate different hull sizes and shapes.

FIG. 2 provides a rear elevation view of the trailer with a boat in place (Non-essential items have been removed from the view for purposes of visual clarity). The reader will note in this example that rear cross beam 26 is attached to left and right beams 12, 14 using U-bolts 40. U-bolts are a common method of attachment but certainly not the only method. Each bunk is connected to the rear cross beam using a pair of mounting brackets 38. The lower portions of the mounting brackets are attached to rear cross beam 26 using U-bolts 40. Bunks 32, 34 are attached to mounting brackets 38 in this example by passing a set of transverse bolts through the mounting brackets and the bunks, then securing the bolts in place with nuts and lock washers.

The reader will observe in FIG. 2 how the “vee” shape of boat hull 36 exerts an outward splaying force on the tops of the two bunks 32, 34. FIG. 3 shows the nature of this three in greater detail. Right bunk 34 is shown in elevation. Boat hull 36 exerts a normal force (En) on the upper inner corner of right bunk 34. A vector diagram is shown. From this diagram the reader can easily discern the presence of a lateral component of the normal force (Ex). This lateral component tends to urge the upper portion of right bunk 34 to the right in the orientation shown in the view. If the upward facing surface of each bunk is angled to match the angle of the boat hull, the surface area of the contact between the hull and the bunk will increase but the overall splaying force will remain the same.

The lateral three exerted can be quite substantial, depending upon the weight of the boat and the shape of its hull. The greater the deadrise angle (angle of a “vee” hull”) the greater the lateral force (Fx) will be. The bunk material tends to warp over time in response to this force. The “L” brackets connecting the bunk to the trailer chassis also tend to plastically deform in response to this lateral force. The result is often a sub-optimal contact between the bunk and the boat hull. These deformations significantly decrease the surface area of contact between the bunks and the boat hull—even when the upper bunk surfaces are angled to match the boat hull. The present solution is to periodically replace the bunks with new material. The present invention provides a solution that can substantially extend the life of the bunks and decrease the risk of catastrophic trailer bunk/bracket failure.

### BRIEF SUMMARY OF THE INVENTION

The present invention comprises a lateral brace for stabilizing a bunk on a boat trailer. The brace includes an anchor bracket attached to a rigid portion of the trailer and a bunk bracket attached to a bunk or to a bracket connecting the bunk to the trailer. An adjustable link connects the anchor bracket to the bunk bracket. The length of the adjustable link can be varied in order to place a desired lateral force on the bunk. This lateral force counteracts the splaying force applied by a boat hull resting on the bunk.

### BRIEF DESCRIPTION OF THE SEVERAL VIEWS OF THE DRAWINGS

FIG. 1 is a perspective view, showing a prior an boat trailer including a pair of bunks.

FIG. 2 is an elevation view, showing how a boat bull sits on the trailer bunks.

FIG. 3 is a detailed elevation view, showing a boat hull resting on a trailer bunk.

FIG. 4 is a perspective view, showing the present invention installed on a prior art trailer.

FIG. 5 is a plan view showing an anchor bracket.

FIG. 6 is an elevation view, showing the anchor bracket of FIG. 5.

FIG. 7 is a perspective view, showing a bunk bracket.

FIG. 8 is an exploded perspective view, showing an adjustable brace in a disassembled state.

FIG. 9 is an exploded perspective view, showing an exemplary installation of the invention on a prior art trailer.

FIG. 10 is an elevation view, showing an exemplary installation of the invention on a prior art trailer.

FIG. 11 is an elevation view, showing an exemplary installation of the invention on a prior art trailer.

FIG. 12 is a perspective view of the bunk bracket.

FIG. 13 is a perspective view, showing the connection of the inventive adjustable link between the trailer chassis and a bunk mounting bracket.

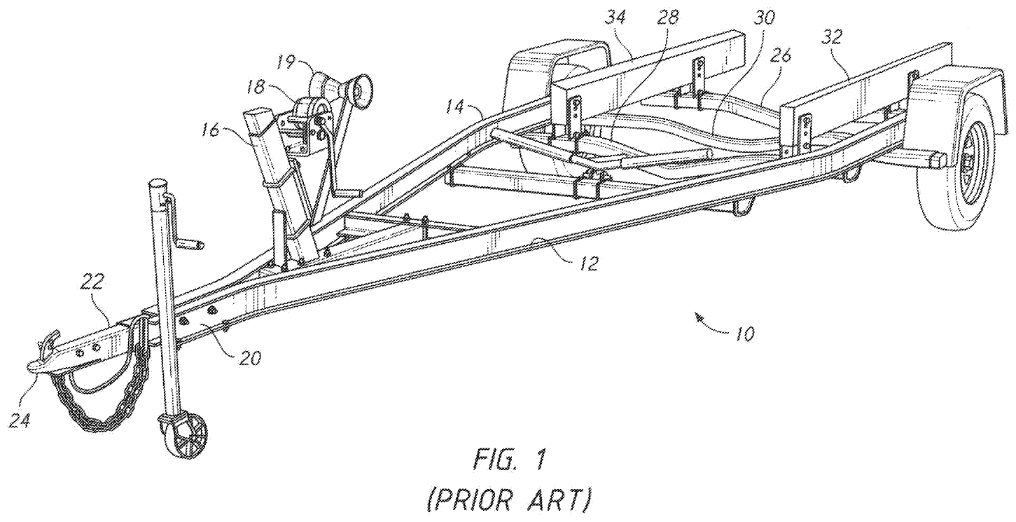

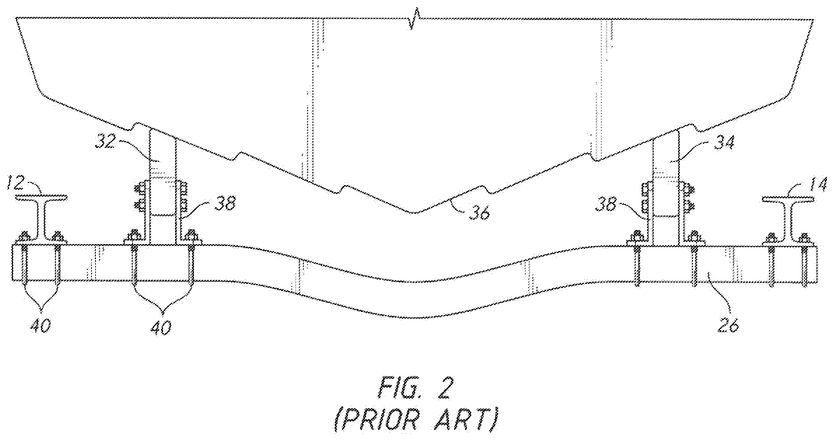

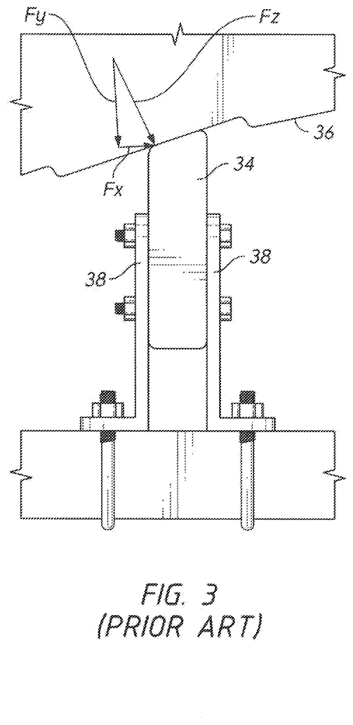

### REFERENCE NUMERALS IN THE DRAWINGS

10 trailer

12 left beam

14 right beam

16 winch post

18 winch

20 junction

22 tongue

24 hitch

26 rear cross beam

28 central cross beam

30 axle

32 left bunk

34 right bunk

36 boat hull

38 mounting bracket

40 U-bolt

42 anchor bracket

44 bunk bracket

45 bunk bracket

46 adjustable link

48 mounting hole

49 mounting hole

50 transverse hole

52 bottom

54 side wall

56 upper transverse hole

57 side wall

58 lower transverse hole

59 mounting wall

60 mounting hole

61 mounting hole

62 first threaded shaft

64 second threaded shaft

66 turnbuckle

68 first threaded receiver

70 second threaded receiver

72 integral hex

74 jam nut

76 enlarged end

78 transverse hole

80 enlarged end

82 transverse hole

83 bolt

84 bolt

86 nut

88 nut

### DETAILED DESCRIPTION OF THE INVENTION

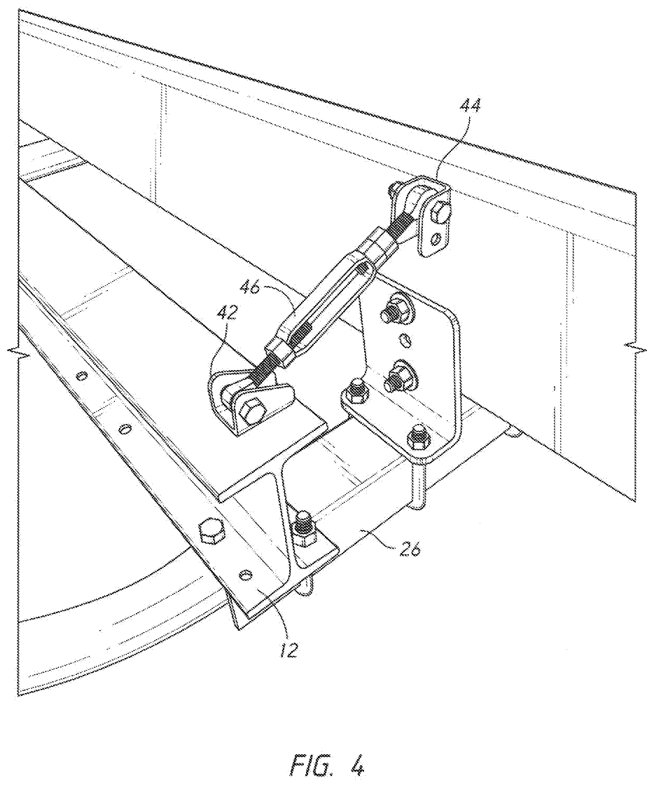

FIG. 4 provides a perspective view of the present invention installed on a prior art trailer. Anchor bracket 42 is attached to a portion of the trailer chassis—in this case to led beam 12. Bunk bracket 44 is attached to the left bunk as shown. It is preferable to attach the bunk bracket to the upper lateral side of the bunk. Adjustable link 46 connects anchor bracket 42 to bunk bracket 44.

It is preferable to provide a pivotal connection between the first end of adjustable link 46 and anchor bracket 42. It is also preferable to provide a pivotal connection between the second end of the adjustable link and the bunk bracket. Adjustable link 40 can be any device that allows an adjustment to be made in the length between its first end and its second end, while also maintaining a fixed length once the adjustment is made. In The example of FIG. 4, a turnbuckle is used as the adjustable link.

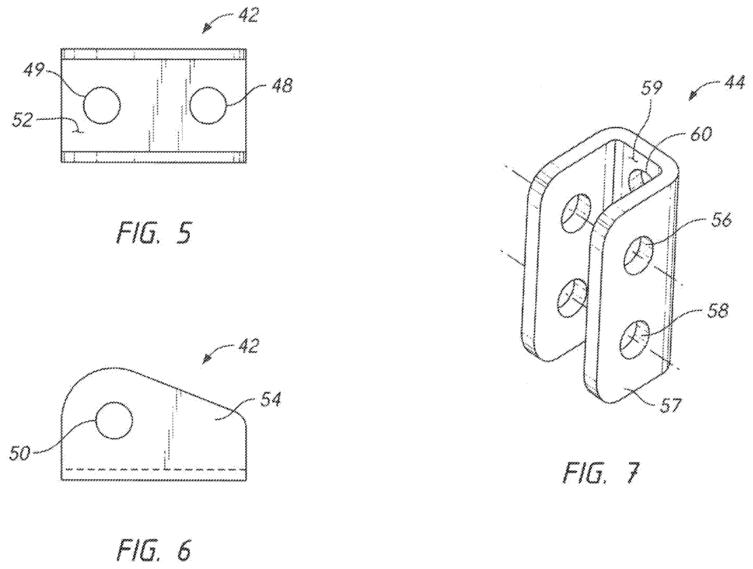

FIGS. 5 through 8 illustrate details of the exemplary embodiment shown in FIG. 4. FIGS. 5 and 6 show a plan view and a side elevation view—respectively—of anchor bracket 42. This bracket has a U-shaped section, with side walls 54 extending upward from bottom 52. Transverse hole 50 passes laterally through the two side walls. The transverse hole provides an attachment for a pin-type joint so that a pivotal connection can be made between anchor bracket 42 and adjustable link 46.

Mounting holes 48 and 49 are provided in bottom 52. These mounting hole allow a bolt to be passed through the anchor bracket and a portion of the trailer chassis in order to secure the anchor bracket to the trailer chassis. Multiple holes are preferably provided to create additional mounting options.

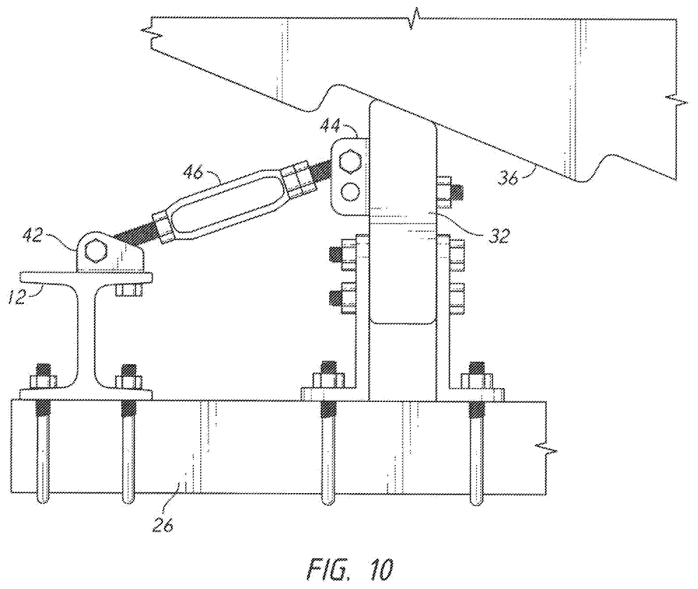

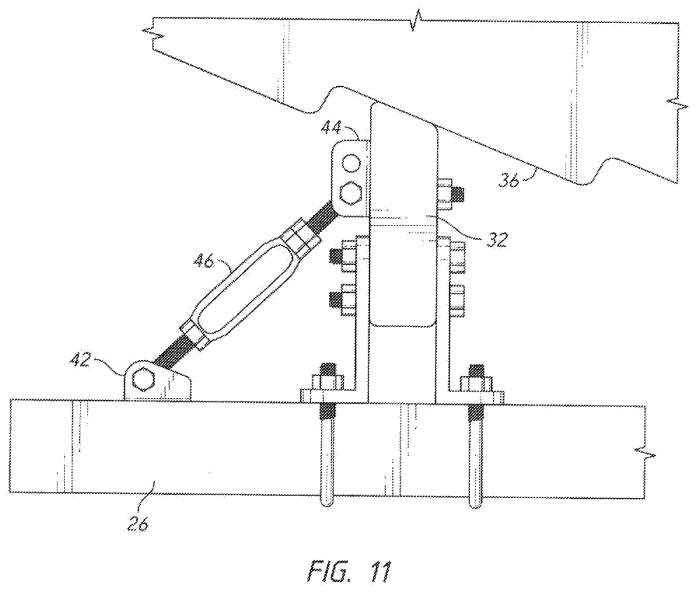

FIG. 7 depicts bunk bracket 34. Mounting wall 59 is configured to mate to the side of a bunk. One or more mounting holes 60, 61 are provided (see FIG. 12). These allow a bolt to be passed through the bunk bracket to connect the bunk bracket to some suitable portion of a bunk assembly. A nut can then be secured on the free end of the bolt to secure the assembly together. It is preferable to provide different sizes for mounting holes 60, 61, in order to accommodate different bunk bolt sizes. Once the bracket is attached to the bunk (either directly or to a bunk mounting bracket) it is preferable to attach adjustable link using the upper of the two transverse holes 56, 58. This configuration allows the upper portion of the bunk bracket to contact the bunk as high as possible—thereby maximizing the rotational counter-pressure. This, while at the same time, allowing the bolt attaching the bunk bracket to the bunk to pass through the lower of the two mounting holes 60, 61. The lower position of the mounting bolt allows the bob head to have adequate clearance below the inner upper bunk edge. The greater clearance minimizes the risk of contact with the boat hull (In FIG. 10, one can see the relationships of the transverse bolt and the bunk bracket to the upper bunk surface).

The majority of bunk bracket 44 should extend above the position of the particular mounting hole 60, 61 selected (in order to provide stable configuration when adjustable link 46 is connected and placed in compression). The user may need to reorient the bunk bracket to place the majority of the bracket above the mounting hole 60, 61 that is selected.

Two side walls 57 join to mounting wall 59 so that the bunk bracket has a U-shaped cross section. Upper transverse hole 56 and lower transverse hole 58 pass laterally through two side walls 57. These transverse holes provide for the attachment of a pit type joint so that a pivotal connection can be made between bunk bracket 44 and adjustable link 46. Only one of the two holes will be used for a given installation. The provision of two transverse holes provides flexibility regarding where the pivotal connection between the adjustable link and the bunk bracket is made.

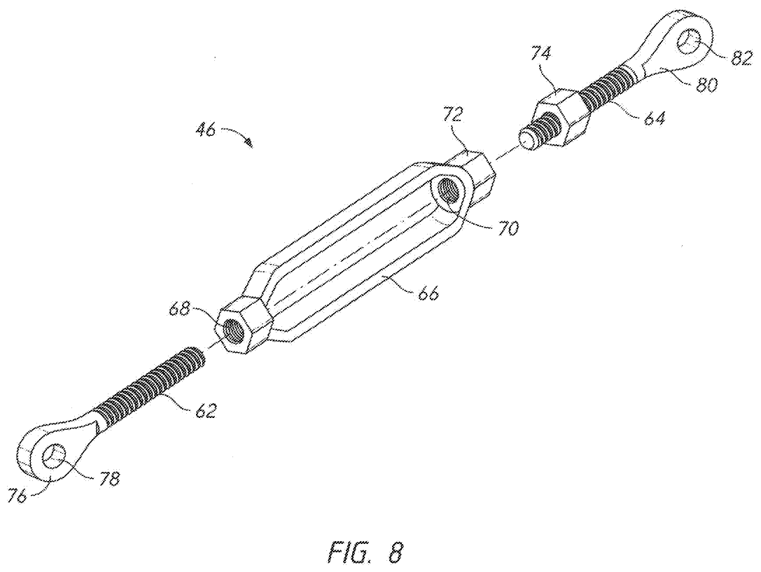

FIG. 8 shows an exploded view of an exemplary adjustable link 46. In this example a turnbuckle is used for the adjustment. First threaded shaft 62 includes a right-hand external thread. This threaded shaft threads into first threaded receiver 68 on turnbuckle 66. First threaded receiver 68 also includes a right-hand thread (though obviously an internal one). First threaded shaft 62 includes an enlarged end 76. The enlarged end includes transverse hole 78.

Second threaded shaft 64 includes a left-hand external thread. The second threaded shaft threads into second threaded receiver 70, which also has a left-hand thread. Second threaded shaft 64 includes an enlarged end 80 having a transverse hole 82. Those skilled in the art will readily understand how the illustrated device operates. First and second threaded shafts 62, 64 are connected to the anchor bracket and the bunk bracket—respectively—using pins or bolts passed through transverse holes 78, 82. The connecting bolts or pins prevent the rotation of first threaded shaft 62 and second threaded shaft 64. If turnbuckle 66 is turned in a first direction then enlarged ends 76, 80 with more away from each other. If turnbuckle 66 is turned in the opposite direction then enlarged ends 76, 80 will move toward each other.

Returning now to FIG. 4, the operation of the device will be explained. As explained previously, anchor bolt 42 is connected to the trailer chassis (in this case left beam 12) and bunk bracket 44 is connected to the left lateral side of the left bunk. First end of adjustable link 46 is pivotally connected to anchor bracket 42 using a transverse bolt—as shown. Likewise, the second end of adjustable link 46 is pivotally connected to bunk bracket 44—using a second transverse bolt in this example. The user is thereby able to selectively apply an inward force (“inward” force with respect to the orientation of the trailer) on the upper portion of the left bunk.

Once the desired amount of extension for the adjustable link is established, it is important to be able to lock the extension mechanism so that it does not change over time. FIG. 8 shows one type of locking mechanism. Jam nut 74 is threaded onto one of the two threaded shafts 62, 64. Once the desired amount of extension is reached, jam nut 74 is turned until it abuts integral hex 72. A pair of wrenches is then used (one on the integral hex and one on the jam nut) to lock the jam nut against the integral hex. As those skilled in the art will realize, the presence of the locked jam nut will prevent the rotation of the turnbuckle with respect to the threaded shafts until the jam nut is released.

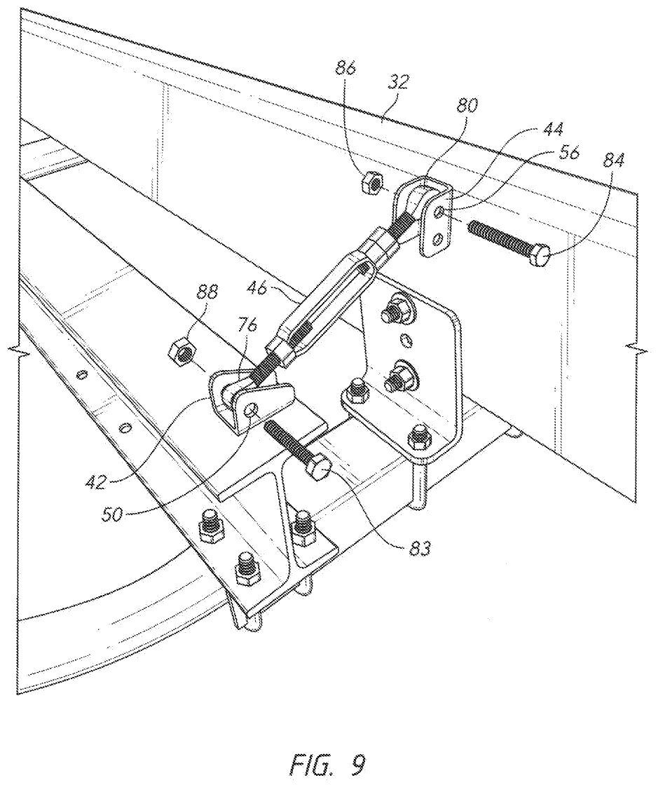

FIG. 9 shows an exploded perspective view in which the components creating the pivotal connections between the adjustable link and the anchor and bunk, brackets are shown more clearly. Enlarged end 76 is positioned within anchor bracket 42 and the transverse hole through enlarged end 76 is aligned with transverse hole 50 in the, anchor bracket. Bolt 83 is then passed through the aligned holes and secured with nut 88 on its free end. A securing device such as a lock washer, a cottar key, or safety wire can be used to retain the bolt in position.

Enlarged end 80 is placed within bunk bracket 44 with its transverse hole aligned in this example with upper transverse hole 56 through bunk bracket 44. Bolt 34 is then passed through the aligned transverse holes and secured with nut 86 on its free end. A securing device may also be added.

When first installing the inventive device it will normally be necessary to adjust the length of adjustable link 46. This may be done by securing one end of the link to one of the brackets and then turning the turnbuckle until the transverse hole in the opposite end aligns with the transverse hole in the other bracket.

FIG. 10 shows an elevation view of the installed invention in operation. Anchor bracket 42 is bolted to the top flange of left beam 12 in this example. Bunk bracket 44 is connected via a transverse through bolt to left bunk 32. Boat hull 36 rests atop the left bunk and exerts an outward lateral force on the bunk as explained previously. Adjustable link 46 is turned in order to place a desired inward lateral force on the bunk. This adjustment may be made with the boat in place on the trailer. As an example, the length of the adjustable bracket can be increased until the bunk reaches a purely vertical position (as shown). At this point the jam nut is advanced and locked in place to secure the desired extension.

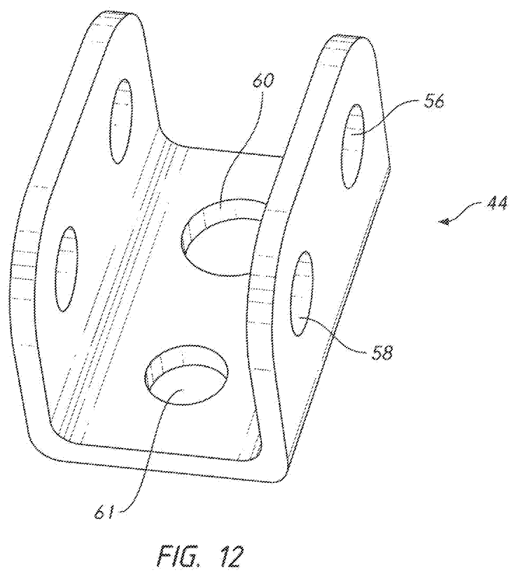

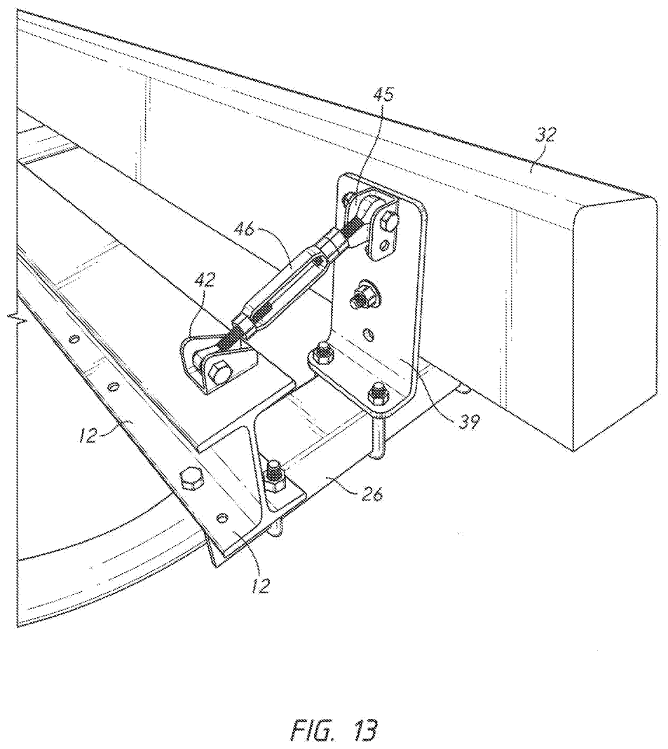

FIG. 11 shows a second exemplary installation. In this case anchor bracket 26 has been connected to rear cross beam 26. Bunk bracket 44 is attached to the bunk as for the prior example. The adjusting and securing operations are the same. The installation of the adjustable bunk braces for the right bunk will be a mirror image of those illustrated for the left bunk.

There are many other possible mounting scenarios. The anchor bracket is connected to the trailer chassis in any suitable location, and this location will vary for different trailer types. It will often also be desirable to provide two or more adjustable bunk braces for a single bunk. Thus, a trailer with a left bunk and a right bunk could have four separate adjustable bunk braces—two for each bunk. Other embodiments will include more than four separate adjustable bunk braces.

The material selected for the adjustable bunk brace is important. The brace is subjected to considerable compressive loading and will of course be immersed in water from time to time. Galvanized steel is a suitable choice, as is stainless steel. For aluminum trailers it is desirable to consider galvanic corrosion. Electrically insulating contact pads may be used or sacrificial metals may be used to limit the effect of galvanic corrosion.

Many other variations and features will occur to those skilled in the art. These include:
1. Welding the anchor bracket to the trailer chassis.
2. Providing the anchor brackets in suitable locations as part of the trailer manufacturing process.
3. Using locking pins instead of bolts to create the desired pivotal connections.
4. Using a cottar key to lock the rotation of the turnbuckle rather than a jam nut.

The preceding description contains significant detail regarding the novel aspects of the present invention. It should not be construed, however, as limiting the scope of the invention but rather as providing illustrations of the preferred embodiments of the invention. Accordingly, the scope of the invention should be determined by reference to the claims rather than the examples given.

Having described my invention, I claim:

1. A bunk brace for a boat trailer having a trailer chassis and a bunk assembly, comprising:
(a) an anchor bracket connected to said trailer chassis;
(b) a bunk bracket connected to said bunk assembly;
(c) an adjustable link having a first end and a second end:
(d) wherein said first end of said adjustable link is pivotally connected to said anchor bracket;
(e) wherein said second end of said adjustable link is pivotally connected to said bunk bracket; and
(f) wherein said first and second ends of said adjustable links are connected by a turnbuckle.

2. The bunk brace for a boat trailer as recited in claim 1, wherein said anchor bracket is connected to a longitudinal beam of said boat trailer.

3. The bunk brace for a boat trailer as recited in claim 1, wherein said anchor bracket is connected to a cross beam of said trailer.

4. The bunk brace for a boat trailer as recited in claim 1, wherein said adjustable link further comprises:
(a) a first threaded shaft pivotally connected to said anchor bracket;
(b) said first threaded shaft being threaded into a first threaded receiver in said turnbuckle;
(c) a second threaded shaft pivotally connected to said bunk bracket;
(d) said second threaded shaft being threaded into a second threaded receiver in said turnbuckle; and
(e) a jam nut configured to selectively lock one of said first and second threaded shafts to said turnbuckle, thereby preventing rotation of said turnbuckle.

5. The bunk brace for a boat trailer as recited in claim 1, wherein said bunk bracket contains a plurality of transverse holes, each of which can be used to create said pivotal connection between said second end of said adjustable link and said bunk bracket.

6. The bunk brace for a boat trailer as recited in claim 1, wherein said pivotal connection between said second end of said adjustable link and said bunk bracket is made by passing a bolt through said second end of said adjustable link and one of said transverse holes through said bunk bracket.

7. The bunk brace for a boat trailer as recited in claim 2, wherein said adjustable link further comprises:
(a) a first threaded shaft pivotally connected to said anchor bracket;
(b) said first threaded shaft being threaded into a first threaded receiver in said turnbuckle;
(c) a second threaded shaft pivotally connected to said bunk bracket;
(d) said second threaded shaft being threaded into a second threaded receiver in said turnbuckle; and
(c) a jam nut configured to selectively lock one of said first and second threaded shafts to said turnbuckle, thereby preventing rotation of said turnbuckle.

8. The bunk brace for a boat trailer as recited in claim 3, wherein said adjustable link further comprises:
(a) a first threaded shaft pivotally connected to said anchor bracket;
(b) said first threaded shall being threaded into a first threaded receiver in said turnbuckle;
(c) a second threaded shaft pivotally connected to said bunk bracket;
(d) said second threaded shaft being threaded into a second threaded receiver in said turnbuckle; and
(e) a jam nut configured to selectively lock one of said first and second threaded shafts to said turnbuckle, thereby preventing rotation of said turnbuckle.

9. The bunk brace for u boat trailer as recited in claim 1, wherein said bunk bracket is connected to an upper lateral side of said bunk assembly.

10. The bunk brace for a boat trailer as recited in claim 2, wherein said bunk bracket is connected to an upper lateral side of said bunk assembly.

11. A bunk brace for a boat trailer having a trailer chassis and a bunk, comprising:
(a) an anchor bracket connected to said trailer chassis;
(b) a bunk bracket connected to said bunk assembly;
(c) an adjustable link having a first end and a second end;
(d) wherein said first end of said: adjustable link is connected to said anchor bracket;
(e) wherein said second end of said adjustable link is connected to said bunk bracket;
and
(f) wherein said adjustable link is configured to that said distance between said first and second ends of said adjustable link can be altered and then fixed to remain constant.

12. The bunk brace for a boat trailer as recited in claim 11, wherein said anchor bracket is connected to a longitudinal beam of said boat trailer,

13. The bunk brace for a boat trailer as recited in claim 11, wherein said anchor bracket is connected to a cross beam of said trailer.

14. The bunk brace for a boat trailer as recited in claim 11, wherein said adjustable link further comprises;
(a) a turnbuckle;
(b) a first threaded shaft pivotally connected to said anchor bracket;
(c) said first threaded shaft being threaded into a first threaded receiver in said turnbuckle;
(d) a second threaded shaft pivotally connected to said bunk bracket;
(e) said second threaded shaft being threaded into a second threaded receiver in said turnbuckle; and
(f) a jam nut configured to selectively lock one of said first and second threaded shafts to said turnbuckle, thereby preventing rotation of said turnbuckle.

15. The bunk brace for a boat trailer as recited in claim 14, wherein said bunk bracket contains a plurality of transverse holes, each of which can be used to create said pivotal connection between said second end of said adjustable link and said bunk bracket.

16. The bunk brace for a boat trailer as recited in claim 14, wherein said pivotal connection between said second end of said adjustable link and said bunk bracket is made by passing a bolt through said second end of said adjustable link and one of said transverse holes through said bunk bracket.

17. The bunk brace for a boat trailer as recited in claim 12, wherein said adjustable link further comprises:
(a) a turnbuckle:
(b) a first threaded shaft pivotally connected to said anchor bracket;
(c) said first threaded shaft being threaded into a first threaded receiver in said turnbuckle;
(d) a second threaded shaft pivotally connected to said bunk bracket;
(e) said second threaded shaft being threaded into a second threaded receiver in said turnbuckle; and
(f) a jam nut configured to selectively lock one of said first and second threaded shafts to said turnbuckle, thereby preventing rotation of said turnbuckle.

18. The bunk brace for a boat trailer as recited in claim 13, wherein said adjustable link further comprises:
(a) a turnbuckle;
(b) a first threaded shaft pivotally connected to said anchor bracket;
(c) said first threaded shaft being threaded into a first threaded receiver in said turnbuckle;
(d) a second threaded shaft pivotally connected to said bunk bracket:
(e) said second threaded shaft being threaded into a second threaded receiver in said turnbuckle; and
(f) a jam nut configured to selectively lock one of said first and second threaded shafts to said turnbuckle, thereby preventing rotation of said turnbuckle.

19. The bunk brace for a boat trailer as recited in claim 11, wherein said bunk bracket is connected to an upper lateral side of said bunk assembly

20. The bunk brace for a boat trailer as recital in claim 12, wherein said bunk bracket is connected to an upper lateral side of said bunk assembly.
